(19) United States
(12) Patent Application Publication
(10) Pub. No.: US 2026/0169430 A1
(43) Pub. Date: Jun. 18, 2026

(54) REDUCED-INERTIA HOROLOGY MOBILE, IN PARTICULAR FOR AN ESCAPEMENT MECHANISM

(71) Applicant: ETA SA Manufacture Horlogère Suisse, Grenchen (CH)

(72) Inventors: Pascal WINKLER, St-Blaise (CH); Dominique LECHOT, Les Reussilles (CH); Jean-Jacques BORN, Morges (CH); Gianni DI DOMENICO, Neuchâtel (CH); Mohammad Hussein KAHROBAIYAN, Boudevilliers (CH)

(73) Assignee: ETA SA Manufacture Horlogère Suisse, Grenchen (CH)

(21) Appl. No.: 19/410,000

(22) Filed: Dec. 5, 2025

(30) Foreign Application Priority Data
Dec. 18, 2024 (EP) 24221245.4

(51) Int. Cl. G04B 15/14

(52) U.S. Cl. CPC G04B 15/14

(57) ABSTRACT

A horology mobile (20, 30), in particular for an escapement mechanism (50), the mobile (20, 30) including a central hub (2) and a circular peripheral toothing (14), the hub (2) being arranged inside the peripheral toothing (14), substantially in the same main plane, the mobile (20, 30) including a first series of blades (5, 15) connecting the hub (2) to the peripheral toothing (4), the blades (5, 15) being distributed around the hub (2) in the main plane, in which the blades (5, 15) are arranged substantially tangentially to the circumference of the hub (2), the direction of the blades (5) forming an angle comprised between −20° and +20° with the tangent to the hub (2), preferably between −10° and +10°, or even between −5° and +5°.

### CROSS-REFERENCE TO RELATED APPLICATIONS

This application claims priority to European Patent Application No. 24221245.4, filed on Dec. 18, 2024, the entire contents of which are incorporated herein by reference.

### TECHNICAL FIELD OF THE INVENTION

The present invention relates to a reduced-inertia horology mobile, in particular for an escapement mechanism.

### TECHNOLOGICAL BACKGROUND

In most mechanical watches, the energy required to rotate the hands (for example, the minute and hour hands) is accumulated in a barrel, then dispensed by a sprung balance system, which comprises a flywheel called a balance, combined with a spring in the form of a strip wound into a spiral, called a balance spring

At an inner end, the balance spring is attached to an arbor that rotates with the balance; at an outer end, the balance spring is attached to a balance spring stud fitted on a stud holder, which is itself attached to a fixed bar (or cock).

The rotation of the balance is maintained—and its oscillations counted—by an escapement mechanism comprising a pallet driven by a low amplitude oscillating movement, provided with two or three pallets that engage the teeth of an escapement wheel. When thus engaged, the escapement wheel is forced into a step-by-step rotational movement at a frequency determined by the oscillation frequency of the pallet, which is itself set to the oscillation frequency of the sprung balance.

With a conventional escapement mechanism, the oscillation frequency is around 4 Hz, or approximately 28,800 vibrations/hour (A/h). Good horologists aim to ensure that the sprung balance oscillates isochronously and steadily (meaning that the rate remains constant).

Today, the balance spring can be replaced with a flexible guide as the spring part to form a virtual pivot. Flexible guides with virtual pivots make it possible to significantly improve horology resonators. The simplest are cross-blade pivots, consisting of two guides with straight crossed blades. These two blades can be either three-dimensional in two different planes or two-dimensional in the same plane, in which case they are soldered together at their crossing point. But there are also RCC (Remote Center Compliance) guides with uncrossed blades, which have straight blades that do not cross. Such a resonator is described in documents EP14199039 and EP16155039.

However, such a flexible guide must have a certain rigidity to guide the resonator effectively, such that the balance has a much smaller amplitude, the angle of rotation being from 10° to 40°, whereas with a balance spring the angle of rotation is 330°. Moreover, the balance oscillates at a much higher frequency than a balance mounted on a balance spring.

As the oscillation amplitude is reduced and the frequency increased, new escapement mechanism configurations have been invented to function with a flexibly guided regulating organ. For example, patents CH710524 and CH713150 describe specific escapement mechanisms for flexible guides.

However, these escapement mechanisms tend to be inefficient and to stop in the event of shocks. Furthermore, they still take up too much space to be easily incorporated into a horology movement.

The limited performance of escapement mechanisms used with a flexible guide resonator is mainly due to the losses caused by the fact that the finishing train, escapement wheel and pallet have to be set in motion, and then stopped, a number of times equivalent to twice the oscillation frequency every second.

The inertia of the pallet, of the escapement wheel and of the mobiles in the finishing train near the escapement wheel are therefore crucial to achieving acceptable performance.

### SUMMARY OF THE INVENTION

One purpose of the present invention is to provide a new type of mobile that enables, in particular, a conventional escapement mechanism to function efficiently with a regulating organ fitted with a flexible guide.

To this end, the invention relates to a horology mobile, in particular for an escapement mechanism, the mobile comprising a central hub and a circular peripheral toothing, the hub being arranged inside the peripheral toothing, substantially in the same main plane, the mobile comprising a first series of blades connecting the hub to the peripheral toothing, the blades being distributed around the hub in the main plane.

The invention is remarkable in that the blades are arranged substantially tangentially to the circumference of the hub, the direction of the blades forming an angle comprised between −20° and +20° with the tangent to the hub, preferably between −10° and +10°, or even between −5° and +5°.

This blade arrangement makes it possible to improve the rigidity of the mobile, in particular to avoid the risk of blades buckling when the mobile meshes with another mobile in a gear system. It also avoids having to arrange a large number of blades, as on an early spoked bicycle wheel, in which the spokes were arranged radially on the hub.

Indeed, by choosing an appropriate direction of rotation, the blades essentially undergo a longitudinal pull and shear stress is reduced.

The invention significantly decreases the inertia of the mobile, as the blades are much lighter and thinner than the arms that usually connect the hub to the peripheral toothing in a conventional horology mobile.

According to a particular embodiment of the invention, the horology mobile has a rotational inertia of less than 5 mg·mm², preferably less than 3 mg·mm², or even less than 2 mg·mm².

According to a particular embodiment of the invention, the thickness of a blade corresponds to the following equation:

$$e \leq \frac{h}{3} ,$$

preferably

$$e \leq \frac{h}{5} ,$$

wherein h is the height of the blade.

According to a particular embodiment of the invention, each blade in the first series is arranged in a direction forming an angle with the direction of the preceding blade, in which angle

$$α = \frac{2 π}{N} ,$$

wherein N is the number of blades in the first series.

According to a particular embodiment of the invention, the blades in the first series are evenly distributed around the hub.

According to a particular embodiment of the invention, the blades are straight.

According to a particular embodiment of the invention, the horology mobile comprises a second series of blades connecting the hub to the peripheral toothing in the main plane, so as to form an array of blades intersecting with the first series of blades.

According to a particular embodiment of the invention, the blades in the second series are arranged substantially tangentially to the circumference of the hub.

According to a particular embodiment of the invention, the array forms a star-shaped structure.

According to a particular embodiment of the invention, the blades in the second series are curved.

According to a particular embodiment of the invention, the peripheral toothing comprises teeth, each tooth being arranged at the junction of the free ends of a blade in the first series and of a blade in the second series.

According to a particular embodiment of the invention, the peripheral toothing comprises an annular rim fitted with teeth.

According to a particular embodiment of the invention, the annular rim is crossed out.

The invention also relates to an escapement mechanism comprising a pallet and such a reduced-inertia horology mobile as an escapement wheel, the escapement mechanism being configured to engage with a regulating organ in a horology movement.

According to a particular embodiment of the invention, the regulating organ comprises a flexible guide.

According to a particular embodiment of the invention, the escapement mechanism comprises a second reduced-inertia horology mobile as an intermediate mobile between the seconds wheel and the escapement wheel, the second horology mobile meshing with the first horology mobile.

The invention also relates to a horology movement comprising such an escapement mechanism.

### BRIEF DESCRIPTION OF THE FIGURES

Other features and advantages of the invention will be more clearly apparent from reading the following description of a particular embodiment of the invention, provided merely as an illustrative and non-limiting example, and from the appended figures, among which:

FIG. 1 schematically shows a top view of a horology mobile, according to a first embodiment of the invention;

FIG. 2 schematically shows a top view of a horology mobile, according to a second embodiment of the invention;

FIG. 3 schematically shows a perspective view of the second embodiment of the horology mobile in FIG. 2;

FIG. 4 schematically shows a top view of a variant of the second embodiment of the horology mobile in FIG. 2;

FIG. 5 schematically shows a top view of a horology mobile, according to a third embodiment of the invention;

FIG. 6 schematically shows a top view of an escapement mechanism comprising a horology mobile, according to the third embodiment of the invention;

FIG. 7 schematically shows an enlarged top view of part of the escapement mechanism in FIG. 6,

FIG. 8 schematically shows a top view of an escapement mechanism comprising two horology mobiles according to the invention;

FIG. 9 schematically shows a top view of a regulating organ associated with the escapement mechanism in FIG. 8, and

FIG. 10 schematically shows a cross-sectional view of the regulating organ associated with the escapement mechanism in FIG. 9 without a flexible guide.

### DETAILED DESCRIPTION OF THE INVENTION

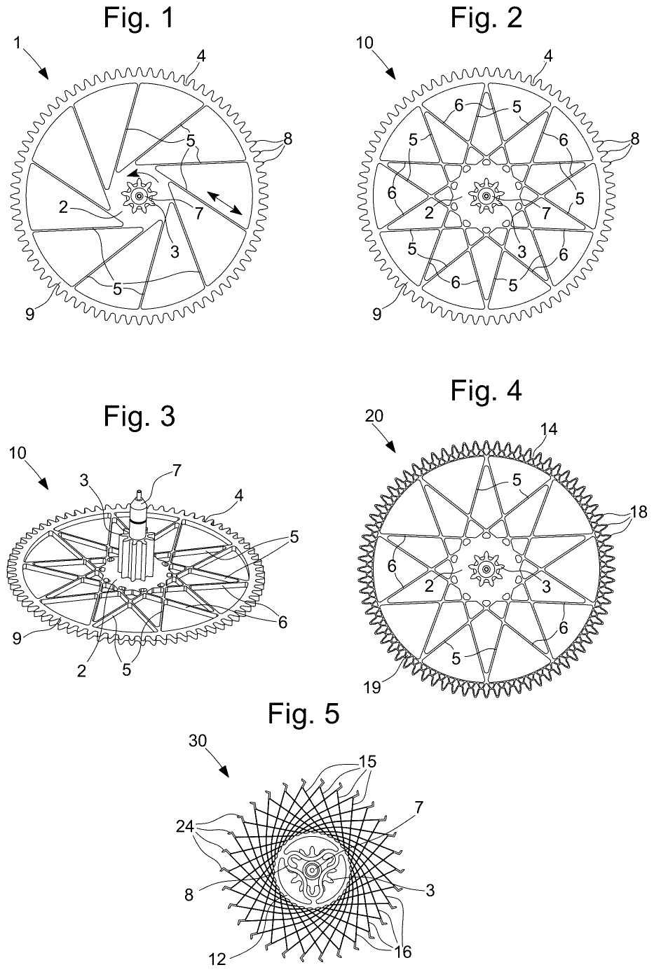

FIGS. 1 to 5 show different embodiments of horology mobiles 1, 10, 20, 30, in particular for an escapement mechanism 50.

Each horology mobile 1, 10, 20, 30 comprises a hub 2 and a peripheral toothing 4. The hub 2 is arranged inside the peripheral toothing 4, preferably substantially in the same main plane.

In FIGS. 1 to 3, the peripheral toothing 4 comprises an annular rim 9, 19 fitted with teeth 8, 18, while in the embodiment shown in FIG. 4, the peripheral toothing 14 comprises a rim 19 and crossed out teeth 18. The peripheral toothing 4 comprises two superimposed sinusoids.

In these embodiments, the horology mobile 1, 10, 20, 30 also comprises an arbor 7 and a pinion 3, the arbor 7 being arranged through the hub 2 and the pinion 3 being mounted on the arbor 7 above the hub 2.

In FIG. 1, the horology mobile 1 comprises a first series of blades 5 connecting the hub 2 to the peripheral toothing 4.

The blades 5 in the first series are evenly distributed around the hub 2 in the main plane. Preferably, the blades 5 in the first series are straight. Alternatively, the blades 5 in the first series are curved.

According to the invention, the blades 5 in the first series are arranged in a direction substantially tangential to the hub 2. For example, the direction of the blades 5 forms an angle comprised between −20° and +20° with the tangent, preferably between −10° and +10° or even between −5° and +5°.

The blades 5 in the first series are arranged in a direction forming an angle with the direction of the previous or next blade 5, in which angle

$$α = \pm \frac{2 π}{N} ,$$

wherein N is the number of blades 5 in the first series. For example, in FIG. 1, the horology mobile 1 comprises ten blades 5. Each blade 5 is arranged in a direction that is at a 36° angle with the direction of the next blade 5 or the direction of the previous blade 5. The blades 5 are arranged clockwise.

In the embodiments in FIGS. 2 to 5, the horology mobiles 10, 20 comprise a second series of blades 6 connecting the hub 2 to the peripheral toothing 4 in the main plane.

The blades 6 in the second series are arranged in the same main plane. Thus, the blades 5 and 6 in the first series and in the second series form an array of intersecting blades.

In the embodiment in FIGS. 2, 3 and 4, the blades 6 in the second series are arranged substantially tangentially to the hub 3, as are the blades 5 in the first series, the characteristics being the same, but arranged counterclockwise.

A blade 5 in the first series and a blade 6 in the second series are joined in pairs at the peripheral toothing 4. This results in a star-shaped array of blades 5, 6.

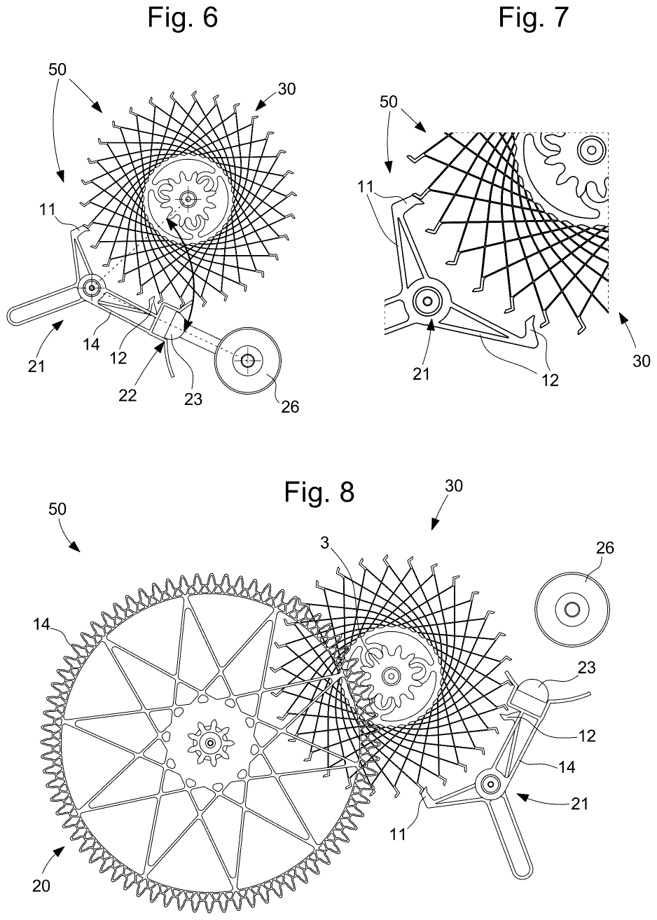

FIG. 5 shows another horology mobile 30 that is more specifically suited to an escapement mechanism 50, such as the one shown in FIGS. 6 to 8.

In this embodiment, the horology mobile 30 also comprises a hub 3 and two series of blades 5, 16, but the peripheral toothing 24 does not comprise an annular rim. The peripheral toothing 24 comprises a tooth arranged at the junction of the free ends of a blade 5 in the first series and of a blade 16 in the second series. Moreover, the blades 16 in the second series are curved.

Preferably, to minimise the inertia of the mobiles 1, 10, 20, 30, the thickness of each blade 5, 6, 16 correspond to the following equation:

$$e \leq \frac{h}{3} ,$$

wherein h is the height of the blade, preferably

$$e \leq \frac{h}{5} .$$

These configurations and parameters enable horology mobiles to have a rotational inertia of less than 5 mg·mm², preferably less than 3 mg·mm², or even less than 2 mg·mm².

Preferably, the horology mobiles 1, 10, 20, 30 are made of the same material and are obtained by a deep photolithography method, such as UV-LIGA or DRIE, in materials such as NiP or silicon.

For example, these reduced-inertia mobiles are used in horology movement escapement mechanisms.

In FIGS. 6 to 8, the escapement mechanism 50 comprises a first horology wheel 30 according to the configuration in FIG. 5 as the escapement mobile, and a pallet 21.

The pallet 21 is fitted with two arms 11, 12, with the ends forming two pallet stones engaging with the teeth 18 of the first horology mobile 30.

The arms 11, 12 of the pallet 21 engage with the first reduced-inertia horology mobile 30, and alternately interact with the teeth 18 of the first horology mobile 30 to regulate the rate.

The pallet 21 also comprises a laterally extending longitudinal part 14 and is fitted with a fork 22 at its end to engage an ellipse 23 on an inertial element 26.

To further reduce the inertia and improve the response of the escapement mechanism 50, the latter also comprises a second horology mobile 20, the second horology mobile 20 meshing with the first horology mobile 30, such as a seconds mobile. In this example, the second horology mobile 20 corresponds to the embodiment shown in FIG. 4.

The teeth 14 on the second horology mobile 20 mesh with the pinion 3 on the first horology mobile 30.

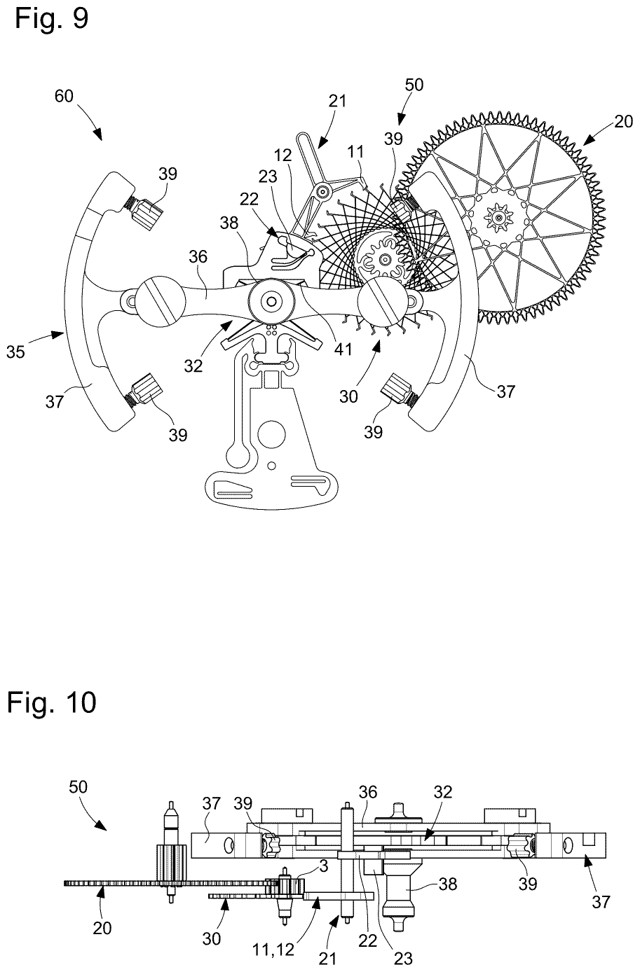

In FIGS. 9 and 10, such a reduced-inertia escapement mechanism 50 is associated with a regulating organ 60. The regulating organ 60 comprises a balance 35 and resilient means 32 for returning the balance 35.

The balance 35 is shaped like a bone fitted with a longitudinal portion 36 and with a lateral portion 37 in the form of a circular arc at each end of the longitudinal portion 36. The balance 35 further comprises stops concentric with the virtual axis of rotation fitted in the middle of the longitudinal portion 36 and screws 39 for setting the inertia of the balance arranged in the lateral portions 37.

The balance 35 is mounted on the resilient return means 5 to enable it to perform a rotational oscillatory movement around a virtual centre of rotation. The resilient return means 32 are connected directly to the balance 35.

The resilient return means 32 comprise a system of flexible blades 37, in this example two pairs of crossed flexible blades 37 arranged in series and forming a double pivot to improve the angle of rotation of the balance 35.

An ellipse 23 extends under the balance 35 from the longitudinal portion 36 to engage with the fork 22 on the pallet 21. The ellipse is attached to the balance 35.

Such a regulating organ 60 has a high oscillation frequency. Thus, a reduced-inertia escapement mechanism 50 according to the invention can function optimally at this frequency.

Naturally, the invention is not limited to the embodiments described with reference to the figures, and variants could be envisaged without departing from the scope of the invention.

1. A horology mobile for an escapement mechanism, comprising:
a central hub and a circular peripheral toothing, the hub being arranged inside the peripheral toothing, substantially in the same main plane; and
a first series of blades connecting the hub to the peripheral toothing, the blades being distributed around the hub in the main plane,
wherein the blades are arranged substantially tangentially to the circumference of the hub, the direction of the blades forming an angle comprised between −20° and +20° with the tangent to the hub.

2. The horology mobile according to claim 1, wherein the mobile has a rotational inertia of less than 5 mg·mm².

3. The horology mobile according to claim 1, wherein the thickness of the blade corresponds to the following equation:
$$e \leq \frac{h}{3} ,$$
wherein h is the height of the blade.

4. The horology mobile according to claim 1, wherein each blade in the first series is arranged in a direction forming an angle with the direction of the preceding blade, in which angle
$$α = \frac{2 π}{N} ,$$
wherein N is the number of blades in the first series.

5. The horology mobile according to claim 1, wherein the blades in the first series are evenly distributed around the hub.

6. The horology mobile according to claim 1, wherein the blades in the first series are straight.

7. The horology mobile according to claim 1, further comprising a second series of blades connecting the hub to the peripheral toothing in the main plane, so as to form an array of blades intersecting with the first series of blades.

8. The horology mobile according to claim 7, wherein the blades in the second series are arranged substantially tangentially to the hub.

9. The horology mobile according to claim 7, wherein the array forms a star-shaped structure.

10. The horology mobile according to claim 7, wherein the blades in the second series are curved.

11. The horology mobile according to claim 7, wherein the peripheral toothing comprises teeth, each tooth being arranged at the junction of the free ends of a blade in the first series and of a blade in the second series.

12. The horology mobile according to claim 1, wherein the peripheral toothing comprises an annular rim fitted with teeth.

13. The horology mobile according to claim 12, wherein the annular rim is crossed out.

14. An escapement mechanism comprising a pallet and a first horology mobile according to claim 1, the first horology mobile forming the escapement wheel in the escapement mechanism.

15. The escapement mechanism according to claim 14, further comprising a second horology mobile, the second horology mobile meshing with the first horology mobile as an intermediate mobile between the seconds mobile and the escapement mobile.

16. A horology movement comprising the escapement mechanism according to claim 14.
